(19) United States
(12) Patent Application Publication
(10) Pub. No.: US 2025/0027366 A1
(43) Pub. Date: Jan. 23, 2025

(54) SECURITY SCREEN SYSTEM AND ASSEMBLY METHOD

(71) Applicant: Meshtec International Co., Ltd., Chiang Mai (TH)

(72) Inventors: David Neil Edlin, Chiang Mai (TH); Peter Syme Taylor, New Farm (AU)

(21) Appl. No.: 18/769,945

(22) Filed: Jul. 11, 2024

Related U.S. Application Data
(60) Provisional application No. 63/639,086, filed on Apr. 26, 2024.
(60) Provisional application No. 63/528,233, filed on Jul. 21, 2023.

(51) Int. Cl. E06B 9/52

(52) U.S. Cl. CPC E06B 9/52

(57) ABSTRACT

There is provided a security screen system. The system may include a mesh/infill and a frame including a plurality of frame assemblies surrounding the mesh/infill. At least one of the frame assemblies may include: an outer sash including a first sidewall and a second sidewall defining a channel therebetween, each sidewall including a first engagement feature; an inner sash received in the outer sash, the inner sash including a first leg and a second leg for engagement with the first and second sidewall, respectively, each leg including a second engagement feature for engagement with the first engagement feature of a sidewall to facilitate retention of the inner sash within the channel; and an insulator received, at least in part, in the inner sash, and engaging an end of the mesh/infill in the insulator. There are also provided methods of assembling a security screen system.

### CROSS-REFERENCE TO RELATED APPLICATION(S)

This application claims benefit to, and priority to, U.S. Application No. 63/528,233, filed Jul. 21, 2023, and U.S. Application No. 63/639,086, filed Apr. 26, 2024, both of which are incorporated by reference herein in their entirety.

### FIELD

The present application relates to security screen systems, and more particularly, to security screen systems involving mesh and/or other infill secured in a frame.

### BACKGROUND

Security screen systems are available for doors and windows. These systems generally involve securing a mesh, or other infill material, within a frame by use of certain fasteners. An inherent issue with security screens is around securing, fixing, or fastening the mesh or other infill into the door or window frame with a fixing system that is both strong and secure enough to either meet or exceed current standards. Current fasteners typically involve variations on a theme of screws, rivets, wedges, tape, glue, or a combination thereof, to secure the infill within the frame.

However, an issue generally with these security screen systems is that they are time-consuming and laborious to manufacture. They typically require manual construction for a large part of the assembly process, which increases both manufacturing time and costs. There is therefore a need for security screen systems that use fasteners that would allow the security screen to be manufactured and assembled by an automated, or at least semi-automated, process. There is a need for a security screen system that is less expensive, quicker, and easier to assemble than current systems.

Accordingly, it would be desirable to have a security screen system that satisfies, at least, two objectives. First, it should provide a secure fixing arrangement that meets or exceeds current standards. Second, it would preferably use fasteners that enable the security screen to be manufactured and assembled by an automated or semi-automated process. In other words, it would be desirable to develop a security system that both meets or exceeds the current standards where manufacture and assembly could be performed by automated or semi-automated processes to reduce the labor-intensive nature of assembly.

### BRIEF DESCRIPTION OF THE DRAWINGS

FIG. 1 shows a screen system including a mesh (and/or other infill) and a frame;

FIG. 2A shows a view of an assembled first frame assembly connecting the mesh (and/or other infill) and the frame;

FIG. 2B shows a side view of the outer sash of the first frame assembly of FIG. 2A;

FIG. 2C shows a side view of the inner sash of the first frame assembly of FIG. 2A;

FIG. 2D shows a side view of the insulator of the first frame assembly of FIG. 2A;

FIG. 3A shows a view of an assembled second frame assembly connecting the mesh (and/or other infill) and the frame;

FIG. 3B shows a side view of the outer sash of the second frame assembly of FIG. 3A;

FIG. 3C shows a side view of the inner sash of the second frame assembly of FIG. 3A;

FIG. 3D shows a side view of the insulator of the second frame assembly of FIG. 3A;

FIG. 4A shows a view of an assembled third frame assembly connecting the mesh (and/or other infill) and the frame;

FIG. 4B shows a side view of the outer sash of the third frame assembly of FIG. 4A;

FIG. 4C shows a side view of the inner sash of the third frame assembly of FIG. 4A;

FIG. 4D shows a side view of the insulator of the third frame assembly of FIG. 4A;

FIG. 5A shows a view of an assembled fourth frame assembly connecting the mesh (and/or other infill) and the frame; and

FIG. 5B shows a side view of the outer sash of the fourth frame assembly of FIG. 5A;

FIG. 5C shows a side view of the inner sash of the fourth frame assembly of FIG. 5A; and

FIG. 5D shows a side view of the insulator of the fourth frame assembly of FIG. 5A;

FIG. 6A shows a view of an assembled fifth frame assembly connecting the mesh (and/or other infill) and the frame;

FIG. 6B shows a side view of the outer sash of the fifth frame assembly of FIG. 6A;

FIG. 6C shows a side view of the inner sash of the fifth frame assembly of FIG. 6A; and

FIG. 7 shows a partial view of a screen system with mesh using the fifth frame assembly of FIG. 6A.

### DETAILED DESCRIPTION

This disclosure has application to a security screen system for doors and windows of buildings, including domestic residences. For illustrative purposes, reference may be made to such applications. However, it is to be understood that this disclosure also has other applications, such as, for example, fencing and balustrade systems, insect screens for doors and windows, screens for covering openings vents, walls or partitions for structures, or any other application where a mesh screen or interface is desirable.

The following description is not to be taken in a limiting sense but is made merely for the purpose of describing the general principles of exemplary embodiments. Reference throughout this specification to “one form,” “one embodiment,” “an embodiment,” “some embodiments”, “an implementation”, “some implementations”, “some applications”, or similar language means that a particular feature, structure, or characteristic described in connection with the embodiment is included in at least one embodiment of the present disclosure. Thus, appearances of the phrases “in one embodiment,” “in an embodiment,” “in some embodiments”, “in some implementations”, and similar language throughout this specification do not all refer to the same embodiment.

The terms “top” and “bottom,” “upper” and “lower” and “vertical” and “horizontal as may be used herein are by way of example and illustrative purposes only and are not meant to limit the description of the embodiments inasmuch as the referenced item can be exchanged in position and orientation. Also, as used herein, the terms “substantially” and/or “about” mean that the specified dimension or parameter may be varied within an acceptable manufacturing tolerance for a given application.

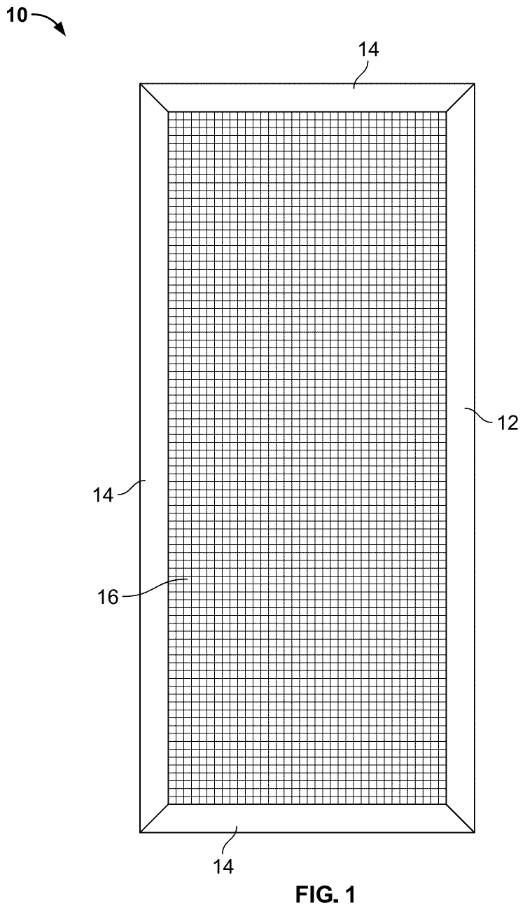

FIG. 1 shows a security screen system 10 that includes a rectangular frame 12 (or sash) composed of multiple frame assemblies 14 (in this case, four frame assemblies). The frame assemblies 14 define an opening that is occupied by a mesh/infill screen 16. The rectangular frame extends about and supports the mesh/infill screen 16. The material of the mesh/infill screen 16 may be any of various types of infill materials, such as, for example, stainless steel wire, a perforated metal sheet, insect resistant fabric, etc. The frame assemblies 14 are typically aluminum channels with a variety of internal structures. The edges of the mesh/infill screen 16 are fastened within the frame assemblies 14, which are in turn joined to one another at the corners of the frame 12. Details of various embodiments of frames, frame assemblies, mesh/infill screens, and other aspects of security screen systems are described, for example, in U.S. Pat. Nos. 6,802,357 and 8,191,606, which are incorporated by reference herein in their entirety.

At a high level, this disclosure generally involves various fastening assemblies for use in holding and maintaining the mesh (or infill) in the security screens. Each fastening system generally includes an outer sash, an inner sash, and an insulator that receives the mesh/infill. It is generally contemplated that the inner sash and the insulator can be inserted into the outer sash using an automated or semi-automated process and machinery, such as, for example, an adapted or modified press. As addressed further below, the wings (or legs) of the inner sash and the wings (or lips) of the insulator are designed such that they are able to be pushed/inserted into place by machine to increase the strength of each frame assembly. The use of a fastener, such as a support screw or rivet, also greatly enhances the tensile strength of the infill material and better secures it into the outer sash. In addition, it should be understood that the terms “mesh” and “infill” are used broadly in this disclosure. The term “infill” is intended broadly to refer to any sort of sheet-like or other material that can be used in the systems and methods described herein.

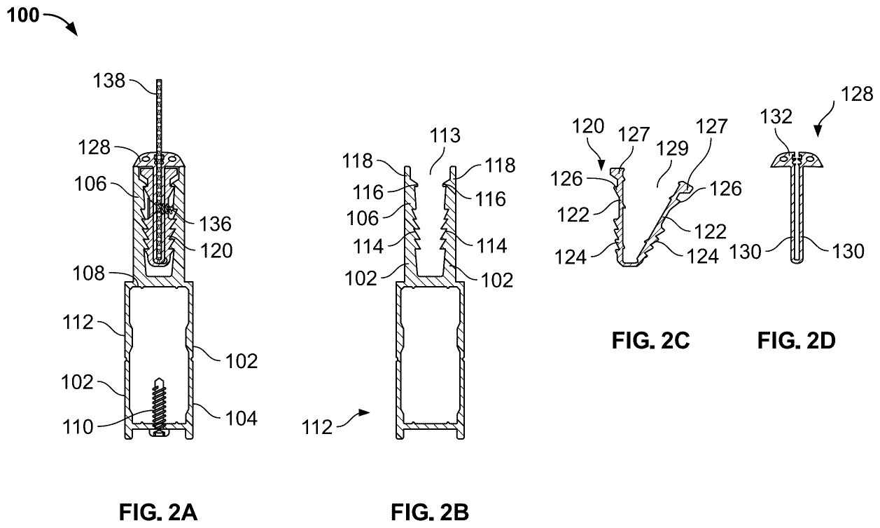

FIGS. 2A, 2B, 2C, and 2D show a first embodiment of a frame assembly 100, which generally illustrates a serrate lock with push plug concept. FIG. 2A shows the frame assembly 100 in an assembled condition. In one form, the frame assembly 100 includes an outer sash 112 that includes two opposing sidewalls 102 that are generally parallel to one another. Each sidewall 102 preferably has a base portion 104 and a top portion 106 separated by a dividing wall 108, and the top portion 106 may have a narrower width than the base portion 104. The base portion 104 preferably includes one or more corner fixing screws 110 that may be used to connect one frame assembly 100 to another at the corners of the frame 10. In this form, the top portion 106 is preferably U-shaped and defines a channel 113, or recess, that is open toward the interior of the security screen system 10.

FIG. 2B shows the outer sash 112 prior to assembly. In one form, the outer sash 112 may be composed of aluminum material, although other materials may also be used. As can be seen, in this form, the U-shaped top portion 106 includes two sets of serrated teeth 114. Each set is on the interior of a sidewall 102 and face one another. In this form, there are multiple (in this case, four) closely spaced serrations 114 (or barbs or teeth) near the middle of each sidewall 102. The outer sash 112 also preferably includes an additional tooth 116, or serration/barb, on the interior of each sidewall 102 near the upper end of the top portion 106. The serrations 114 and 116 generally act to retain the inner sash 120 in the channel 113, as addressed further below. In this form, the two sidewalls 102 of the outer sash 112 narrow in thickness at the upper end and terminate in two thin walls 118, i.e., walls that are preferably thinner than the remainder of the sidewalls 102, to accommodate a plug, as discussed below.

FIG. 2C shows the inner sash 120 prior to assembly. The inner sash 120 is generally configured to be inserted, received within, and retained by the outer sash 112. The inner sash 120 is preferably in the form of a flexible U-shaped member with two serrated legs 122 (or wings). The inner sash 120 may be composed of aluminum material, although other materials may also be used. As can be seen, the serrations are on the outsides of the two legs 122. A group of closely spaced serrations 124 are preferably configured to engage the corresponding closely spaced serrations 114 on the outer sash 112 so as to retain the inner sash 120 in the channel 113. The inner sash 120 preferably includes an additional tooth 126, or serration, configured to engage the additional tooth 116 on the outer sash 112. In this form, the two legs 122 widen at the upper end and terminate in two wide walls 127, i.e., walls that are preferably as wide or wider than the remainder of the legs 122. These two wide walls 127 (in combination with the insulator) act as a plug to facilitate insertion of the inner sash/insulator combination into the outer sash 112 during assembly.

FIG. 2D shows the insulator 128 prior to assembly. The insulator 128 is generally configured to be inserted and received within a channel 129 (or recess) of the inner sash 120 formed by the two legs 122 of the inner sash 120. The insulator 128 preferably includes two lip portions 130 (or wings) that terminate in a cap 132. The insulator 128 may be composed of santoprene, although other thermoplastic elastomers or other materials may also be used. The lips 130 are configured to be crimped (or pinched or compressed) about the mesh and/or other infill 138 to engage the mesh and/or other infill 138 and allow it to be received within the insulator 128. When assembled, the underside of the cap 132 preferably engages the upper end of the outer sash 112. As can be seen in FIG. 2A, the mesh and/or other infill 138 is preferably fixed in place within the insulator 128 by a fastener 136, such as a support screw or rivet, which is generally inserted at a location at or just above the top of the closely spaced serrations.

In certain circumstances, it has been found desirable to use the serrations as a primary engagement feature between the outer sash 112 and the inner sash 120. The plurality of serrations provides a strong engagement between the outer sash 112 and the inner sash 120 to retain the inner sash 120 within the outer sash 112. These serrations and other engagement features of the outer sash (such as hooks) are described throughout this disclosure. These engagement features of the outer sash generally engage with corresponding engagement features of the inner sash (such as corresponding serrations and hooks). Also, in certain circumstances, the use of a plug formed by the combination of the inner sash 120 and insulator 128 has been found desirable to facilitate application of a pushing or pulling force by machinery for insertion of the inner sash/insulator combination into the outer sash 112.

Further, as addressed above, in one form, it is preferable to use an elastomeric material or other non-metallic material for the insulator 128. In some forms, the mesh and/or other infill 138 may be composed of a strong metallic material, such as stainless steel, and the outer sash 112 and inner sash 120 may be composed of a relatively lightweight metallic material, such as aluminum. It is desirable to have an insulator 128 between the metallic mesh and/or other infill 138 and the metallic inner sash 120 to separate and insulate these components from one another. Otherwise, the direct engagement of certain metallic materials, such as stainless steel and aluminum, may facilitate galvanic corrosion. When stainless steel and aluminum are utilized together in an assembly, the electrons from the aluminum tend to transfer into the stainless steel over time, which leads to weakening of the aluminum. This weakening causes the aluminum to deteriorate and leads to a shorter useful life for the component.

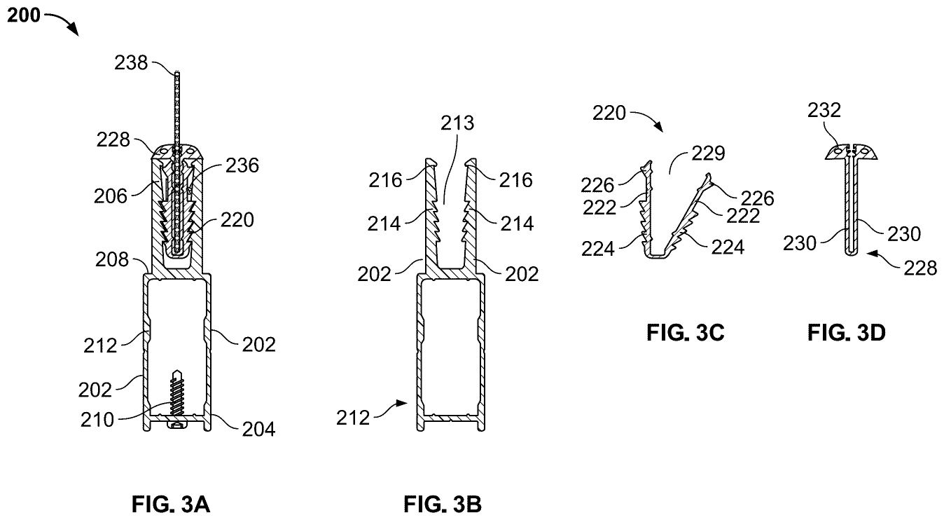

FIGS. 3A, 3B, 3C, and 3D show a second embodiment of a frame assembly 200, which generally illustrates a serrate lock concept (without push plug). FIG. 3A shows the frame assembly 200 in an assembled condition. This second embodiment is generally similar to the first embodiment but with certain structural differences in the outer sash and the inner sash, as described below.

In one form, the frame assembly 200 includes an outer sash 212 that includes two opposing sidewalls 202 that are generally parallel to one another. Each sidewall 202 preferably has a base portion 204 and a top portion 206 separated by a dividing wall 208, and the top portion 206 may have a narrower width than the base portion 204. The base portion 204 preferably includes one or more corner fixing screws 210 that may be used to connect one frame assembly 200 to another at the corners of the frame 10. In this form, the top portion 206 is preferably U-shaped and defines a channel 213, or recess, that is open toward the interior of the security screen system 10.

FIG. 3B shows the outer sash 212 prior to assembly. In one form, like the first embodiment, the outer sash 212 may be composed of aluminum material, although other materials may also be used. As can be seen, in this form, the U-shaped top portion 206 includes two sets of serrated teeth 214. Each set is on the interior of a sidewall 202 and face one another. In this form, there are multiple (in this case, four) closely spaced serrations 214 (or barbs or teeth) near the middle of each sidewall 202. The outer sash 212 also preferably includes an additional tooth 216, or serration/barb, on the interior of each sidewall 202 near the upper end of the top portion 206. The serrations 214 and 216 generally act to retain the inner sash 220 in the channel 213, as addressed further below. In this form, in contrast to the first embodiment, the two sidewalls 202 of the outer sash 212 do not terminate in two thin walls at the upper end. Instead, they terminate in the additional tooth 216 on each sidewall 202.

FIG. 3C shows the inner sash 220 prior to assembly. The inner sash 220 is generally configured to be inserted, received within, and retained by the outer sash 212. The inner sash 220 is preferably in the form of a flexible U-shaped member with two serrated legs 222 (or wings). In one form, like the first embodiment, the inner sash 220 may be composed of aluminum material, although other materials may also be used. As can be seen, the serrations are on the outsides of the two legs 222. A group of closely spaced serrations 224 are preferably configured to engage the corresponding closely spaced serrations 214 on the outer sash 212 so as to retain the inner sash 220 in the channel 213. The inner sash 220 preferably includes an additional tooth 226, or serration, configured to engage the additional tooth 116 on the outer sash 112. In this form, the two legs 222 do not have a widened, plug portion at the upper end. Instead, they terminate in the additional tooth 226 on each leg 222 that is configured to engage the corresponding additional teeth 216 on the outer sash 212.

FIG. 3D shows the insulator 228 prior to assembly. The insulator 228 is preferably similar to the insulator 128 used with the first embodiment. The insulator 228 may be composed of santoprene, although other thermoplastic elastomers or other materials may also be used. It is generally configured to be inserted and received within a channel 229 (or recess) of the inner sash 220 formed by the two legs 222 of the inner sash 220. The insulator 228 preferably includes two lip portions 230 (or wings) that terminate in a cap 232. The lips 230 are configured to be crimped (or pinched or compressed) about the mesh and/or other infill 238 to engage the mesh and/or other infill 238 and allow it to be received within the insulator 228. When assembled, the underside of the cap 232 preferably engages the upper end of the outer sash 212. As can be seen in FIG. 3A, the mesh and/or other infill 238 is preferably fixed in place within the insulator 228 by a fastener 236, such as a support screw or rivet, which is generally inserted at a location at or just above the top of the closely spaced serrations. In one form, the fastener 236 is disposed further away from the bottom of the insulator 228 than the fastener of the first embodiment.

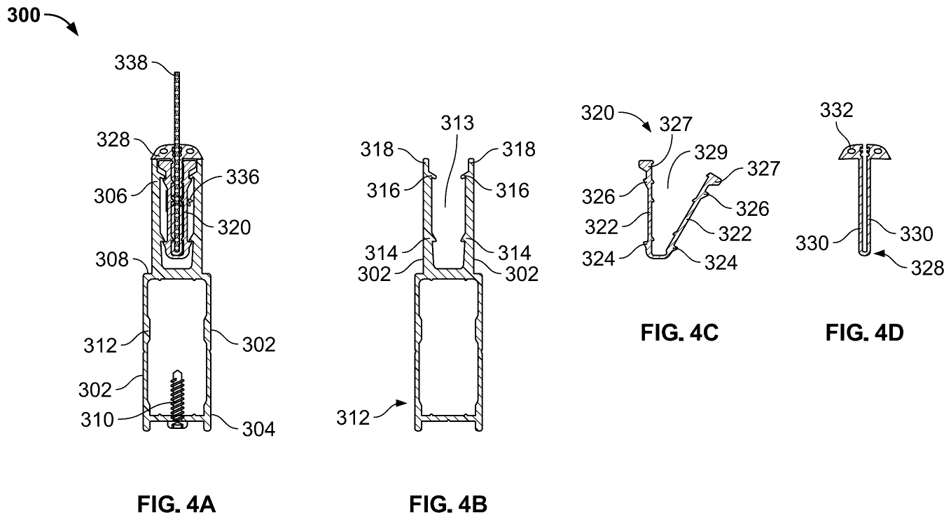

FIGS. 4A, 4B, 4C, and 4D show a third embodiment of a frame assembly 300, which generally illustrates a hook lock with push plug concept. FIG. 4A shows the frame assembly 300 in an assembled condition. This third embodiment is generally similar to the first embodiment but with certain structural differences relating to the serrations in the outer sash and the inner sash, as described below.

In one form, the frame assembly 300 includes an outer sash 312 that includes two opposing sidewalls 302 that are generally parallel to one another. Each sidewall 302 preferably has a base portion 304 and a top portion 306 separated by a dividing wall 308, and the top portion 306 may have a narrower width than the base portion 304. The base portion 304 preferably includes one or more corner fixing screws 310 that may be used to connect one frame assembly 300 to another at the corners of the frame 10. In this form, the top portion 306 is preferably U-shaped and defines a channel 313, or recess, that is open toward the interior of the security screen system 10.

FIG. 4B shows the outer sash 312 prior to assembly. In one form, like the other embodiments, the outer sash 312 may be composed of aluminum material, although other materials may also be used. As can be seen, in this form, the U-shaped top portion 306 does not include the closely spaced serrations (or barbs or teeth) that were present in the first two embodiments. Instead, in this form, the U-shaped top portion 306 includes two hooks 314. Each hook 314 is on the interior of a sidewall 302 and face one another. The outer sash 312 also preferably includes an additional tooth 316, or serration/barb, on the interior of each sidewall 302 near the upper end of the top portion 306. The hooks 314 and additional teeth 316 generally act to retain the inner sash 320 in the channel 313, as addressed further below. In this form, the two sidewalls 302 of the outer sash 312 narrow at the upper end and terminate in two thin walls 318, i.e., walls that are preferably thinner than the remainder of the sidewalls 302, to accommodate a plug, as discussed below.

FIG. 4C shows the inner sash 320 prior to assembly. The inner sash 320 is generally configured to be inserted, received within, and retained by the outer sash 312. The inner sash 320 is preferably in the form of a flexible U-shaped member with two legs 322 (or wings). Like the other embodiments, the inner sash 320 may be composed of aluminum material, although other materials may also be used. As can be seen, there is a hook 324 on the outsides of each of the two legs 322. The hooks 324 are preferably configured to engage the corresponding hooks 314 on the outer sash 312 so as to retain the inner sash 320 in the channel 313. The inner sash 320 preferably includes an additional tooth 326, or serration, configured to engage the additional tooth 316 on the outer sash 312. In this form, the two legs 322 widen at the upper end and terminate in two wide walls 327, i.e., walls that are preferably as wide or wider than the remainder of the legs 322. These two wide walls 327 (in combination with the insulator) act as a plug to facilitate insertion of the inner sash/insulator combination into the outer sash 312 during assembly.

FIG. 4D shows the insulator 328 prior to assembly. The insulator 328 is preferably similar to the insulator used with the other two embodiments. It is generally configured to be inserted and received within a channel 329 (or recess) of the inner sash 320 formed by the two legs 322 of the inner sash 320. The insulator 328 preferably includes two lip portions 330 (or wings) that terminate in a cap 332. The lips 330 are configured to be crimped (or pinched or compressed) about the mesh and/or other infill 338 to engage the mesh and/or other infill 338 and allow it to be received within the insulator 328. When assembled, the underside of the cap 332 preferably engages the upper end of the outer sash 312. As can be seen in FIG. 4A, the mesh and/or other infill 338 is preferably fixed in place within the insulator 328 by a fastener 336, such as a support screw or rivet, which is generally inserted at a location between the hooks 314 and the additional serrations 316.

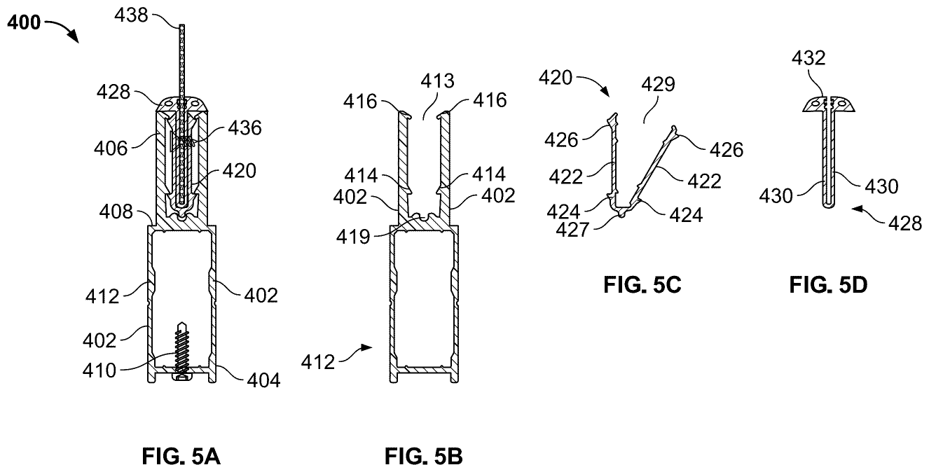

FIGS. 5A, 5B, 5C, and 5D show a fourth embodiment of a frame assembly 400, which generally illustrates a hook lock concept (without push plug). FIG. 5A shows the frame assembly 400 in an assembled condition. This fourth embodiment is generally similar to the third embodiment but with certain structural differences in the outer sash and the inner sash, as described below.

In one form, the frame assembly 400 includes an outer sash 412 that includes two opposing sidewalls 402 that are generally parallel to one another. Each sidewall 402 preferably has a base portion 404 and a top portion 406 separated by a dividing wall 408, and the top portion 406 may have a narrower width than the base portion 404. The base portion 404 preferably includes one or more corner fixing screws 410 that may be used to connect one frame assembly 400 to another at the corners of the frame 10. In this form, the top portion 406 is preferably U-shaped and defines a channel 413, or recess, that is open toward the interior of the security screen system 10.

FIG. 5B shows the outer sash 412 prior to assembly. In one form, like the other embodiments, the outer sash 412 may be composed of aluminum material, although other materials may also be used. As can be seen, in this form, the U-shaped top portion 406 includes two hooks 414. Each hook 414 is on the interior of a sidewall 402 and face one another. The outer sash 412 also preferably includes an additional tooth 416, or serration/barb, on the interior of each sidewall 402 near the upper end of the top portion 406. The hooks 414 and additional teeth 416 generally act to retain the inner sash 420 in the channel 413, as addressed further below. Further, in contrast to the third embodiment, the top portion 406 preferably includes a cavity 419 formed in the dividing wall 408 (floor of the top portion 406) that is configured to receive a portion of the inner sash 420, as addressed below.

FIG. 5C shows the inner sash 420 prior to assembly. The inner sash 420 is generally configured to be inserted, received within, and retained by the outer sash 412. The inner sash 420 is preferably in the form of a flexible U-shaped member with two legs 422 (or wings). Like the other embodiments, the inner sash 420 may be composed of aluminum material, although other materials may also be used. As can be seen, there is a hook 424 on the outsides of each of the two legs 422. The hooks 424 are preferably configured to engage the corresponding hooks 414 on the outer sash 412 so as to retain the inner sash 420 in the channel 413. The inner sash 420 preferably includes an additional tooth 426, or serration, configured to engage the additional tooth 416 on the outer sash 412. In this form, the two legs 422 do not have a widened, plug portion at the upper end. Instead, they terminate in the additional tooth 426 on each leg 422 that is configured to engage the corresponding additional teeth 416 on the outer sash 412. Further, in one form, in contrast to the third embodiment, the inner sash 420 includes a projection 427 that protrudes from the bottom of the “U” and that is configured to be received within the cavity 419 of the outer sash 412.

FIG. 5D shows the insulator 428 prior to assembly. The insulator 428 is preferably similar to the insulator used with the other embodiments. It is generally configured to be inserted and received within a channel 429 (or recess) of the inner sash 420 formed by the two legs 422 of the inner sash 420. Like the other embodiments, the insulator 428 may be composed of santoprene, although other thermoplastic elastomers or other materials may also be used. The insulator 428 preferably includes two lip portions 430 (or wings) that terminate in a cap 432. The lips 430 are configured to be crimped (or pinched or compressed) about the mesh and/or other infill 438 to engage the mesh and/or other infill 438 and allow it to be received within the insulator 428. When assembled, the underside of the cap 432 preferably engages the upper end of the outer sash 412. As can be seen in FIG. 5A, the mesh and/or other infill 438 is preferably fixed in place within the insulator 428 by a fastener 436, such as a support screw or rivet, which is generally inserted at a location between the hooks 414 and the additional serrations 416.

This disclosure is also directed to a method of assembling a security screen system, such as the various embodiments described above, and the discussion of the various embodiments is incorporated herein. Initially, a mesh and/or other infill, an outer sash, inner sash, and insulator, such as described above, may be provided. In one form, the lips (or wings) of the insulator may be crimped (or pinched) about the end of the mesh and/or other infill so as to retain it within the insulator. The insulator may be disposed within the inner sash, and the combination of the mesh and/or other infill, insulator, and inner sash may be fastened (or fixed) together by a fastener.

In this form, the combination of fastened mesh and/or other infill, insulator, and inner sash may be inserted into the channel of the outer sash. A force may be applied to move the fastened mesh and/or other infill, inner sash, and insulator into the channel of the outer sash. The force should be sufficient to move the engagement feature(s) of the inner sash past the engagement feature(s) of the outer sash. It is generally contemplated that this force may be applied as some sort of pushing or pulling force that may be applied in an automated manner by machinery, such as, for example, by some form of adapted or modified press, hydraulic or pneumatic machinery, etc. Alternatively, the combination of fastened mesh and/or other infill, insulator, and inner sash may be inserted into the channel of the outer sash by sliding the inner sash laterally into the channel of the outer sash. Although all or part of the method may be performed in an automated or semi-automated manner, it is also contemplated that, in certain circumstances, the assembly method may be performed entirely manually.

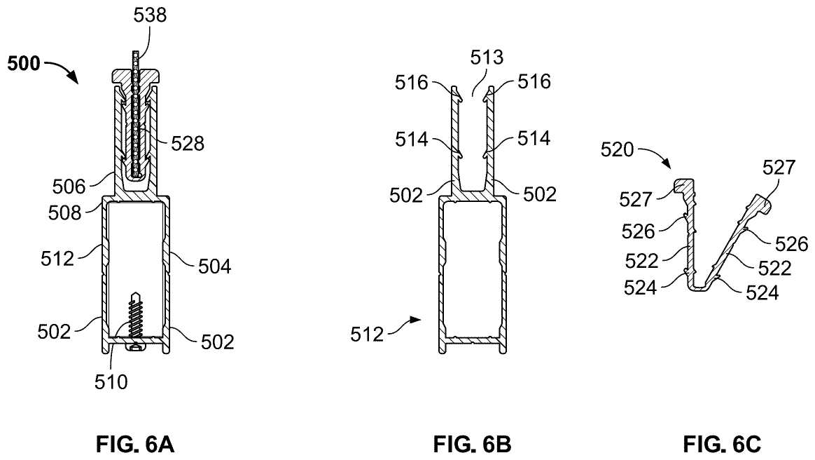

FIGS. 6A, 6B, and 6C show a fifth embodiment of a frame assembly 500, which generally illustrates a plastic inner wedge fixing system. FIG. 6A shows the frame assembly 500 in an assembled condition. This fifth embodiment is generally similar to the previous embodiments but with certain structural differences in the outer sash and the inner sash, and with use of glue or an adhesive strip as the insulator, as described below.

In one form, the frame assembly 500 includes an outer sash 512 that includes two opposing sidewalls 502 that are generally parallel to one another. Each sidewall 502 preferably has a base portion 504 and a top portion 506 separated by a dividing wall 508, and the top portion 506 may have a narrower width than the base portion 504. The base portion 504 preferably includes one or more corner fixing screws 510 that may be used to connect one frame assembly 500 to another at the corners of the frame 10. In this form, the top portion 506 is preferably U-shaped and defines a channel 513, or recess, that is open toward the interior of the security screen system 10.

FIG. 6B shows the outer sash 512 prior to assembly. In one form, like the other embodiments, the outer sash 512 may be composed of aluminum material, although other materials may also be used. As can be seen, in this form, the U-shaped top portion 506 includes two hooks 514. Each hook 514 is on the interior of a sidewall 502 and face one another. The outer sash 512 also preferably includes an additional tooth 516, or serration/barb, on the interior of each sidewall 502 near the upper end of the top portion 506. The hooks 514 and additional teeth 516 generally act to retain the inner sash 520 in the channel 513, as addressed further below.

FIG. 6C shows the inner sash 520 (or plastic inner wedge 520) prior to assembly. The inner sash 520 is generally configured to be inserted, received within, and retained by the outer sash 512. The inner sash 520 is preferably in the form of a flexible U-shaped member with two legs 522 (or wings). In one form, the inner sash 520 may be composed of a plastic material, such as, for example, polyvinyl chloride (PVC), although other materials may also be used (such as, for example, aluminum). As can be seen, there is a hook 524 on the outsides of each of the two legs 522. The hooks 524 are preferably configured to engage the corresponding hooks 514 on the outer sash 512 so as to retain the inner sash 520 in the channel 513. The inner sash 520 preferably includes an additional tooth 526, or serration, configured to engage the additional tooth 516 on the outer sash 512. In this form, each of the two legs 522 preferably terminates in a widened plug (or stopper) portion 527 at the upper end.

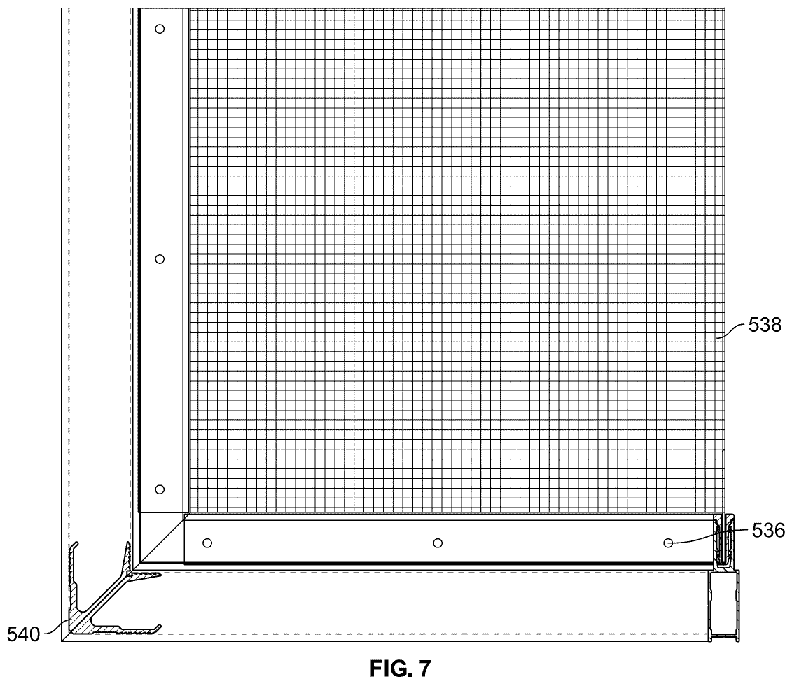

In this form, a glue or adhesive is applied between the mesh/infill 538 and the inner sash 520 and acts as an insulator 528. In one form, it is contemplated that the adhesive 528 may be in the form of a double-sided adhesive strip that is folded and applied to both sides at the edge of the mesh/infill 538. The inner sash 520 may then be applied to the adhesive strip such that the adhesive strip is sandwiched between the mesh/infill 538 and the inner sash 520. This adhesive strip may be in the form of an epoxy adhesive, polyurethane adhesive, or other type of adhesive strip and may be used for fixing the mesh and the inner sash 520 together. Further, optionally, the mesh and/or other infill 538 may be further fixed in place with respect to the inner sash 520 by a fastener 536, such as a support screw or rivet driven through the inner sash 520, as shown in FIG. 7. Although the fastener 536 is shown in FIG. 7, it would ordinarily not be visible when the outer sash 512 is in position over the inner sash 520.

Another example of a method of assembly is now described, such as, for example, involving frame assembly 500. However, it should also be understood that this method may be used for other frame assemblies described in this disclosure. Initially, a sheet of mesh/infill 538 may be laid out on a workspace after it has been cut to a desired size. Next, an insulator 528 (such as, for example, a double-sided adhesive strip) may be applied along one edge of the mesh/infill 538 with the insulator 528 being applied to both sides of the mesh/infill 538. The mesh/infill 538 (with insulator 528) is then inserted into the inner sash 520. The mesh/infill 538 (with insulator 528) is preferably inserted so as to cause engagement by the insulator 528 with the inner sash 520 (and not to have the mesh/infill 538 come into direct contact with the inner sash 520). The inner sash 520 is preferably cut and sized so that it does not overlie the corners of the mesh/infill 538. A tool, such as a rubber mallet, may be used to tap the inner sash 520 and push the combination mesh/infill 538, insulator 528, and inner sash 520 together. Excess portions of the insulator 528 at the corners of the mesh/infill 538 may be cut and removed.

In one form, the inner sash 520 may be riveted, such as by a riveting machine, so that the mesh/infill 538, insulator, and inner sash 520 are held together by a fastener 536. For example, the rivets 536 may be applied with the first rivet starting at 15 mm from a short edge of the inner sash 520 with subsequent rivets 536 being spaced a 150 mm distance from one another. As should be understood, other riveting arrangements and spacing may also be used. The above steps are generally repeated until four inner sashes 520 are fastened about the outer rectangular perimeter of the mesh/infill 538.

Next, three of the inner sashes 520 may each be slid laterally within a corresponding outer sash 512. The three outer sashes 512 are fastened to one another at two corners by one or more corner fixing screws 510 that engage a corner stake 540 or other corner fastening assembly at each corner. Then, the fourth outer sash 512 may be aligned and positioned so that corner fixing screws 510 engage corner stakes 540 at the other two corners. Once positioned, the fourth outer sash 512 may be fastened about the fourth inner sash 520 by using a pulling machine or press (not by sliding engagement) to exert a force and pull (or push) the outer sash 512 toward the interior of the mesh/infill 538 and onto, and covering, the fourth inner sash 520. The corner fixing screws 510 and corner stakes 540 may be secured by auto-crimping, or by applying a crimping force, at the four corners.

Accordingly, generally speaking, pursuant to various embodiments, systems, apparatuses, and methods are provided herein for a security screen system. In one form, the system includes: a mesh and/or other infill, and a frame including a plurality of frame assemblies surrounding the mesh and/or other infill. Further, in this form, in the system, at least one of the frame assemblies includes: an outer sash including a first sidewall and a second sidewall defining a first channel therebetween, each sidewall including at least one first engagement feature; an inner sash received in the outer sash, the inner sash comprising a first leg and a second leg configured for engagement with the first and second sidewall, respectively, each leg including at least one second engagement feature configured for engagement with the at least one first engagement feature of a sidewall to facilitate retention of the inner sash within the first channel; and an insulator received, at least in part, in the inner sash, the insulator configured to engage an end of the mesh and/or other infill in the insulator.

In some implementations, the system further includes a first fastener engaging and retaining the mesh and/or other infill, the inner sash, and the insulator, the first fastener disposed in the first channel. In some implementations, the outer sash further includes a second fastener, the second fastener configured to connect a first frame assembly to a second frame assembly. In some implementations, the two legs of the inner sash define a second channel therebetween, the second channel configured for receiving the insulator therein. In some implementations, the insulator comprises an elastomeric material. In some implementations, the insulator comprises a glue or adhesive configured to affix the mesh and/or other infill to the inner sash. In some implementations, the insulator comprises an adhesive strip composed, at least in part, of an epoxy or polyurethane material. In some implementations, the outer sash and the inner sash each comprise a metal material. In some implementations, the inner sash comprises a plastic material. In some implementations, the insulator includes two lips that are configured for crimping to retain the mesh and/or other infill therebetween. In some implementations, insulator comprises a cap portion that overlies and engages a first end of the first sidewall and a second end of the second sidewall. In some implementations, the at least one first engagement feature of each sidewall includes a plurality of serrations, the first sidewall including a first plurality of serrations and the second sidewall including a second plurality of serrations. In some implementations, the at least one second engagement feature of each leg of the inner sash includes a plurality of serrations, the first leg including a first plurality of serrations and the second leg including a second plurality of serrations. In some implementations, the at least one first engagement feature of each sidewall includes a serration disposed at an end of each sidewall. In some implementations, the at least one second engagement feature of each leg of the inner sash includes a serration disposed at an end of each leg. In some implementations, the at least one first engagement feature of each sidewall includes a hook disposed between a first end and a second end of each sidewall. In some implementations, the at least one second engagement feature of each leg of the inner sash includes a hook disposed between a first end and a second end of each leg. In some implementations, each leg of the inner sash includes a plug portion at an end of each leg, the plug portion being wider than other portions of the leg. In some implementations, the insulator includes a cap portion that overlies the plug portion of each leg. In some implementations, the inner sash includes a projection and the outer sash includes a cavity, the projection configured to be received in the cavity to seat the inner sash within the outer sash.

In another form, there is provided a method of assembling a screen system. The method includes: crimping the lips of the insulator about the end of the mesh and/or other infill; disposing the insulator, at least in part, in the inner sash; and fastening the mesh and/or other infill, the inner sash, and the insulator together. In some implementations, the method may also include: applying a force to move the fastened mesh and/or other infill, inner sash, and insulator into the first channel of the outer sash, the force sufficient to move the at least one first engagement feature past the at least one second engagement feature. In some implementations, the force may be applied by machinery.

In another form, there is provided a method of assembling a screen system, the method including: providing a sheet of mesh and/or other infill material with a rectangular perimeter; applying an insulator to front and rear surfaces of the sheet of mesh and/or other infill material along each of the four edges of the rectangular perimeter; applying four inner sash members to overlie the insulator along each of the four edges, each inner sash member comprising two foldable legs configured to engage the insulator on a side of the insulator opposite the front and rear surfaces of the sheet of mesh and/or other infill material; sliding three outer sash members over three inner sash members along three edges, each outer sash member comprising a first sidewall and a second sidewall defining a channel therebetween for receiving a corresponding inner sash member, each outer sash member including engagement features for engagement with corresponding engagement features of the corresponding inner sash member; and exerting a pushing or pulling force to move a fourth outer sash member over a fourth inner sash member in a direction toward an interior of the sheet of the mesh and/or other infill material. In some implementations, the insulator includes a glue or adhesive configured to affix the mesh and/or other infill to the inner sash members. As should be understood, in this disclosure, the terms inner sash and outer sash are used interchangeably with inner sash member and outer sash member.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the technological contribution. The actual scope of the protection sought is intended to be defined in the following claims.

What is claimed is:

1. A screen system comprising:
a mesh and/or other infill;
a frame including a plurality of frame assemblies surrounding the mesh and/or other infill;
at least one of the frame assemblies comprising:
an outer sash comprising a first sidewall and a second sidewall defining a first channel therebetween, each sidewall including at least one first engagement feature;
an inner sash received in the outer sash, the inner sash comprising a first leg and a second leg configured for engagement with the first and second sidewall, respectively, each leg including at least one second engagement feature configured for engagement with the at least one first engagement feature of a sidewall to facilitate retention of the inner sash within the first channel; and
an insulator received, at least in part, in the inner sash, the insulator configured to engage an end of the mesh and/or other infill in the insulator.

2. The screen system of claim 1, further comprising a first fastener engaging and retaining the mesh and/or other infill, the inner sash, and the insulator, the first fastener disposed in the first channel.

3. The screen system of claim 1, wherein the outer sash further comprises a second fastener, the second fastener configured to connect a first frame assembly to a second frame assembly.

4. The screen system of claim 1, wherein the two legs of the inner sash define a second channel therebetween, the second channel configured for receiving the insulator therein.

5. The screen system of claim 1, wherein the insulator comprises an elastomeric material.

6. The screen system of claim 1, wherein the insulator comprises a glue or adhesive configured to affix the mesh and/or other infill to the inner sash.

7. The screen system of claim 6, wherein the insulator comprises an adhesive strip composed, at least in part, of an epoxy or polyurethane material.

8. The screen system of claim 1, wherein the insulator comprises two lips that are configured for crimping to retain the mesh and/or other infill therebetween.

9. The screen system of claim 1, wherein the insulator comprises a cap portion that overlies and engages a first end of the first sidewall and a second end of the second sidewall.

10. The screen system of claim 1, wherein the at least one first engagement feature of each sidewall comprises a plurality of serrations, the first sidewall comprising a first plurality of serrations and the second sidewall comprising a second plurality of serrations.

11. The screen system of claim 10, wherein the at least one second engagement feature of each leg of the inner sash comprises a plurality of serrations, the first leg comprising a first plurality of serrations and the second leg comprising a second plurality of serrations.

12. The screen system of claim 1, wherein the at least one first engagement feature of each sidewall comprises a serration disposed at an end of each sidewall.

13. The screen system of claim 12, wherein the at least one second engagement feature of each leg of the inner sash comprises a serration disposed at an end of each leg.

14. The screen system of claim 1, wherein the at least one first engagement feature of each sidewall comprises a hook disposed between a first end and a second end of each sidewall.

15. The screen system of claim 14, wherein the at least one second engagement feature of each leg of the inner sash comprises a hook disposed between a first end and a second end of each leg.

16. The screen system of claim 1, wherein each leg of the inner sash comprises a plug portion at an end of each leg, the plug portion being wider than other portions of the leg.

17. The screen system of claim 16, wherein the insulator comprises a cap portion that overlies the plug portion of each leg.

18. The screen system of claim 1, wherein the inner sash comprises a projection and the outer sash comprises a cavity, the projection configured to be received in the cavity to seat the inner sash within the outer sash.

19. A method of assembling the screen system of claim 1, the method comprising:
crimping the insulator about the end of the mesh and/or other infill;
disposing the insulator, at least in part, in the inner sash; and
fastening the mesh and/or other infill, the inner sash, and the insulator together.

20. The method of claim 19 further comprising:
applying a force to move the fastened mesh and/or other infill, inner sash, and insulator into the first channel of the outer sash, the force sufficient to move the at least one first engagement feature past the at least one second engagement feature.

21. A method of assembling a screen system, the method comprising:
providing a sheet of mesh and/or other infill material with a rectangular perimeter having four edges;
applying an insulator to front and rear surfaces of the sheet of mesh and/or other infill material along each of the four edges of the rectangular perimeter;
applying four inner sash members to overlie the insulator along each of the four edges, each inner sash member comprising two foldable legs configured to engage the insulator on a side of the insulator opposite the front and rear surfaces of the sheet of mesh and/or other infill material;
sliding three outer sash members over three inner sash members along three edges, each outer sash member comprising a first sidewall and a second sidewall defining a channel therebetween for receiving a corresponding inner sash member, each outer sash member including engagement features for engagement with corresponding engagement features of the corresponding inner sash member; and
exerting a pushing or pulling force to move a fourth outer sash member over a fourth inner sash member in a direction toward an interior of the sheet of the mesh and/or other infill material.

22. The method of claim 21, wherein the insulator comprises a glue or adhesive configured to affix the mesh and/or other infill to the inner sash members.
